(19) United States
(12) Patent Application Publication
(10) Pub. No.: US 2014/0166906 A1
(43) Pub. Date: Jun. 19, 2014

(54) EXTREME ULTRA VIOLET GENERATION DEVICE

(71) Applicant: SAMSUNG ELECTRONICS CO., LTD., Suwon-si (KR)

(72) Inventors: Eok-bong KIM, Hwaseong-si (KR); Jong-ju PARK, Hwaseong-si (KR); Dong-gun LEE, Hwaseong-si (KR); Seong-sue KIM, Seoul (KR)

(21) Appl. No.: 14/077,292

(22) Filed: Nov. 12, 2013

(30) Foreign Application Priority Data
Dec. 17, 2012 (KR) 10-2012-0147723

(51) Int. Cl. G21K 5/04

(52) U.S. Cl. CPC G21K 5/04
USPC 250/504 R

(57) ABSTRACT

An extreme ultra violet (EUV) generation device includes a light source for outputting laser beam, a pulse width compression system for compressing a pulse width of the laser beam, a gas cell for receiving the laser beam having the compressed pulse width incident from the pulse width compression system and generating EUV light, and a vacuum chamber housing the pulse width compression system and the gas cell.

### CROSS-REFERENCE TO RELATED APPLICATION

Korean Patent Application No. 10-2012-0147723, filed on Dec. 17, 2012, in the Korean Intellectual Property Office, and entitled: “Extreme Ultra Violet Generation Device,” is incorporated by reference herein in its entirety.

### BACKGROUND

1. Field

Embodiments relate to an extreme ultra violet (EUV) generation device, and more particularly, to an EUV semiconductor device having an excellent EUV output characteristic and a long-term stability.

2. Description of the Related Art

With an increase in an integration degree of a semiconductor device, a circuit pattern is miniaturized, and thus resolution of a conventional exposure device using visible ray or ultraviolet ray becomes insufficient. To increase resolution, research into an exposure processing using extreme ultra violet (EUV) light having a wavelength less than 100 nm as an exposure light source is being actively conducted.

### SUMMARY

According to one or more embodiments, there is provided an extreme ultra violet (EUV) generation device including: a light source for outputting laser beam; a pulse width compression system for compressing a pulse width of the laser beam; a gas cell for receiving the laser beam having the compressed pulse width incident from the pulse width compression system and generating EUV; and a vacuum chamber for accommodating the pulse width compression system and the gas cell.

The pulse width may include system may include a chirp mirror.

The pulse width compression system may selectively compress the pulse width of the incident laser beam within a range of 30% and 60%.

The vacuum chamber may include a wave front control unit for controlling a wave front of the laser beam incident into the gas cell.

The wave front control unit may include a deformable mirror (DM).

The wave front control unit may adjust a wave front of the laser beam by applying genetic algorithm (GA).

The vacuum chamber may include a location stabilization system for stabilizing a location of the laser beam.

The location stabilization system may include a plane mirror having partial transparency with respect to light; a first sensor for measuring a signal of the laser beam from light that transmits a first point of the plane mirror; and a first location adjusting unit for adjusting locations of optical components included in the vacuum chamber based on the signal received from the first sensor.

The location stabilization system may include a second sensor for measuring the signal of the laser beam from light that transmits a second point of the plane mirror and a second location adjusting unit for adjusting the locations of optical components included in the vacuum chamber based on the signal received from the second sensor.

The EUV generation device may further include, between the light source and the vacuum chamber, a pulse width magnification system for magnifying the pulse width of the laser beam; and an amplifier for amplifying an output of the laser beam that passes through the pulse width magnification system.

The EUV generation device may further include a focus mirror for collecting the laser beam incident into the gas cell.

According to one or more embodiments, there is provided an extreme ultra violet (EUV) generation device including: a light source for outputting laser beam; a pulse width magnification system for magnifying a pulse width of the laser beam; an amplifier for amplifying an output of the laser beam that passes through the pulse width magnification system; a first pulse width compression system for compressing the pulse width of the amplified laser beam to a first pulse width; a second pulse width compression system for compressing the first pulse width to a second pulse width; a gas cell for receiving the laser beam having the compressed second pulse width incident from the second pulse width compression system and generating EUV; and a vacuum chamber for accommodating the second pulse width compression system and the gas cell.

The EUV generation device may further include a deformable mirror (DM) disposed in the vacuum chamber and controlling a wave front of the laser beam incident into the gas cell.

The EUV generation device may further include a location stabilization system disposed in the vacuum chamber and stabilizing a location of the EUV output from the gas cell.

The second pulse width compression system may include a chirp mirror.

According to one or more embodiments, there is provided an extreme ultra violet (EUV) generation device, including a vacuum chamber for housing a gas cell, a laser beam having a first pulse width being incident on a window in the vacuum chamber; and a pulse width compression system in the vacuum chamber between the window and the gas cell, the pulse width compression system being configured to compress the first pulse width of the laser beam to a second pulse width shorter than the first pulse width, the gas cell being configured to output EUV light in response to the laser beam having the second pulse width.

The EUV generation device may include, between a light source outputting the laser beam and the vacuum chamber, another pulse width compression system for compressing the first pulse width to a third pulse width that is greater than the second pulse width.

The EUV generation device may include, between the light source and the another pulse width compression system, a pulse width magnification system for magnifying the pulse width of the laser beam; and an amplifier for amplifying an output of the laser beam that passes through the pulse width magnification system.

The EUV generation device may include a deformable mirror (DM) disposed in the vacuum chamber and controlling a wave front of the laser beam incident on the gas cell.

The EUV generation device may include a location stabilization system disposed in the vacuum chamber and stabilizing a location of the EUV light output from the gas cell.

### BRIEF DESCRIPTION OF THE DRAWINGS

Features will become apparent to those of skill in the art by describing in detail exemplary embodiments with reference to the attached drawings in which:

FIG. 1 illustrates a schematic view of a configuration of an extreme ultra violet (EUV) generation device, according to an embodiment;

FIG. 2 illustrates a schematic view of a configuration of an EUV generation device, according to another embodiment;

FIG. 3 illustrates a schematic view of a configuration of an EUV generation device, according to another embodiment;

FIGS. 4A through 4C illustrate pulse width adjustment systems available in a pulse width magnification system and pulse width compression systems of EUV generation devices;

FIG. 5 illustrates a diagram for explaining a deformable mirror (DM) available in EUV generation devices; and

FIGS. 6A and 6B illustrate graphs for explaining a location of a pulse width compression system and a self phase modulation (SPM) signal.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, like reference numerals denote like elements, and repeated descriptions will be omitted.

In the present description, terms such as ‘first’, ‘second’, etc. are used to describe various members, components, regions, layers, and/or portions. However, it is obvious that the members, components, regions, layers, and/or portions should not be defined by these terms. The terms do not indicate any particular order or top or bottom or superiority or inferiority, and are used only for distinguishing one member, component, region, layer, or portion from another member, component, region, layer, or portion. Thus, a first member, component, region, layer, or portion which will be described may also refer to a second member, component, region, layer, or portion, without departing from the teachings herein. For example, without departing from the scope of embodiments, a first element may be referred to as a second element, and similarly, a second element may also be referred to as a first element.

Unless defined differently, all terms used in the description including technical and scientific terms have the same meaning as generally understood by those skilled in the art. Terms as defined in a commonly used dictionary should be construed as having the same meaning as in an associated technical context, and unless defined apparently in the description, the terms are not ideally or excessively construed as having formal meaning.

As used herein, the term “and/or” includes any and all combinations of one or more of the associated listed items.

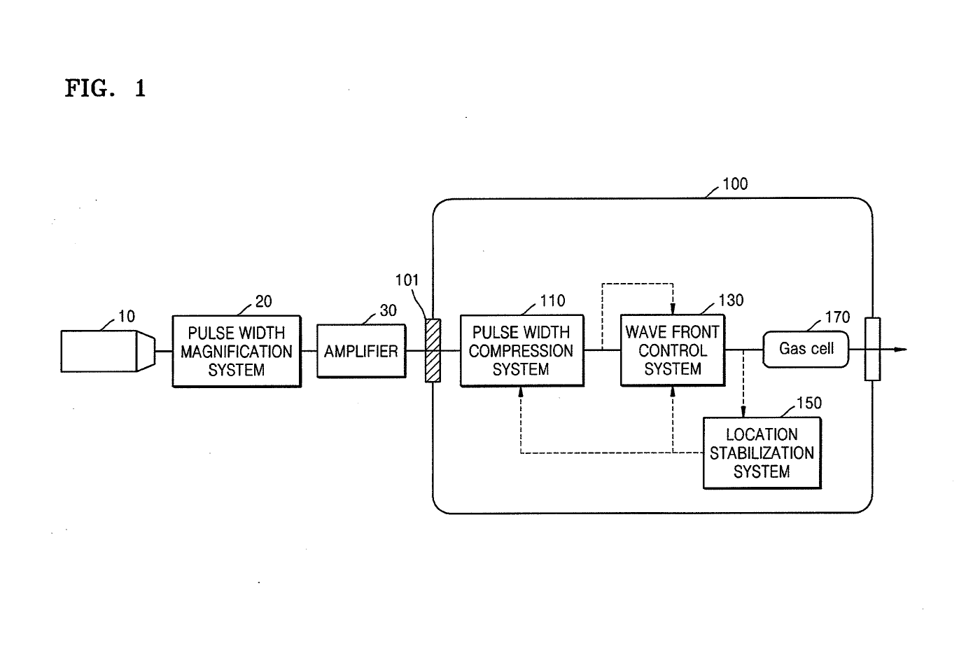

FIG. 1 illustrates a schematic view of a configuration of an extreme ultra violet (EUV) generation device 1, according to an embodiment.

Referring to FIG. 1, the EUV generation device 1 includes a light source 10 that outputs a laser beam, a vacuum chamber 100, a gas cell 170 disposed within the vacuum chamber 100, and a pulse width compression system 110. The EUV generation device 1 may further include a pulse width magnification system 20, an amplifier 30, a wave front control system 130, and a location stabilization system 150.

The light source 10 may output the laser beam having a femtosecond pulse width. For example, the light source 10 may be a femtosecond dye laser, a femtosecond optical fiber laser, or a femtosecond solid state laser, e.g. a titanium (Ti) sapphire laser. The laser beam may be an infrared (IR) laser. The light source 10 may further include auxiliary devices suitable for adjusting optical power or a waveform and cycle of the output light. A pulse width of the laser beam output by the light source 10 may be several to several tens of femtoseconds.

The pulse width magnification system 20 and the amplifier 30 may be configured to amplify an output of the laser beam output by the light source 10 to an output required by a system. The pulse width magnification system 20 unfolds a pulse of the laser beam output by the light source 10 in a time domain so that the laser beam may pass through a gain medium of the amplifier 30 to obtain a sufficient energy without damaging the gain medium. The pulse width magnification system 20 may include one of a diffraction grating pair, a prism pair, and a chirp mirror pair. The pulse width magnification system 20 may magnify the pulse width of the laser beam by several times to several tens of times. In some embodiments, the pulse width output by the pulse width magnification system 20 may be several hundreds of femtoseconds.

The vacuum chamber 100 may be configured to prevent laser beam necessary for generating extreme ultra violet (EUV) light from being absorbed in the atmosphere by placing the elements in the vacuum atmosphere. The vacuum chamber 100 may further include a vacuum pump (not shown) and a vacuum gauge (not shown) that are installed in the outside so as to form the vacuum atmosphere. A vacuum level of the vacuum chamber 100 may be equal to or less than 10⁻³ Ton during the generation of the EUV. The vacuum chamber 100 may include a window 101 for receiving incident laser beam generated by the light source 10. The window 101 may be formed of quartz, but embodiments are not limited thereto. For example, the window 101 may be formed of a material for minimizing occurrence of self phase modulation (SPM) that will be described later.

The gas cell 170 may be disposed within the vacuum chamber 100, and may be filled with gas such as neon (Ne), zeon (Xe), or argon (Ar). When a laser beam is incident on the gas cell 170, the laser beam and the gas in the gas cell 170 interact with each other to generate higher order harmonic waves. In particular, electrons separated from atoms of the gas in the gas cell 170 have kinetic energy due to the laser beam and then are recombined with the atoms of the gas, generating higher order harmonic waves having diverse wavelength ranges. Light having a wavelength of a desired region may be selected from the generated higher order harmonic waves. That is, a wavelength of an EUV region may be selected. For example, light having a wavelength of approximately 13.5 nm may be selected.

The pulse width compression system 110 is used to compress the pulse width of the laser beam incident into the gas cell 170 and is disposed within the vacuum chamber 100. The laser beam needs very high peak power to generate the higher order harmonic waves when the laser beam is incident on the gas cell 170. To obtain the high peak power, the pulse width compression system 110 may be used to temporally compress the pulse of the laser beam. The pulse width compression system 110 may be used to compress the pulse width of the laser beam from several times to several tens of times, e.g., may output a laser beam having a pulse width of, for example, from several to several tens femtoseconds. The pulse width compression system 110 may include one of the diffraction grating pair, the prism pair, and the chirp mirror pair. The pulse width compression system 110 may be plural in consideration of a pulse compressibility.

The pulse width compression system 110 may be disposed within the vacuum chamber 100 to prevent a spectrum distortion phenomenon due to SPM that may occur when the laser beam passes through the window 101 of the vacuum chamber 100. If the laser beam has high power and a short pulse width, SPM, i.e., a non-linear phenomenon that occurs when the laser beam passes through the medium, may be increased compared to a case where the laser beam has low power and a long pulse width.

Therefore, the EUV generation device 1 may inhibit occurrence of SPM by allowing the laser beam having the long pulse width to pass through the window 101. That is, the spectrum distortion phenomenon by SPM may be prevented, thereby increasing EUV generation efficiency.

The wave front control system 130 may control a wave front of the laser beam before being incident into the gas cell 170. A distortion may be present in the wave front of the laser beam output by the light source 10 and/or may arise when the laser beam passes through diverse optical components. The wave front control system 130 may compensate for the distorted wave front of the laser beam and control the distorted wave front in a required shape of the wave front. For example, the wave front control system 130 may control the wave front of the laser beam to have a Gaussian profile. The wave front control system 130 may include a wave front observing unit (not shown) that observes the wave front of the laser beam in real time and a wave front adjusting unit (not shown) that adjusts the wave front based on the real-time observed wave front.

Although the wave front control system 130 of FIG. 1 is configured to control the wave front of the laser beam that passes through the pulse width compression system 110, embodiments are not limited thereto. For example, the wave front control system 130 may be disposed in front of the pulse width compression system 110 and may control the wave front of the laser beam before the laser beam passes through the pulse width compression system 110.

The location stabilization system 150 may be configured to adjust locations of optical components within the EUV generation device 1 in real time to stabilize a path of the laser beam incident into the gas cell 170 and further generate a stable generation of EUV. The location stabilization system 150 may include a sensor for detecting a signal of the laser beam and a location adjusting unit for adjusting the locations of the optical components. The sensor may sense a part of the laser beam incident into the gas cell 170. The location adjusting unit may adjust the locations of the optical components included in the pulse width compression system 110 and/or the wave front control system 130 in real time based on the sensed light laser. The sensor may use a mirror through which a part of the laser beam, for example, approximately 1%, may pass in sensing the part of the laser beam.

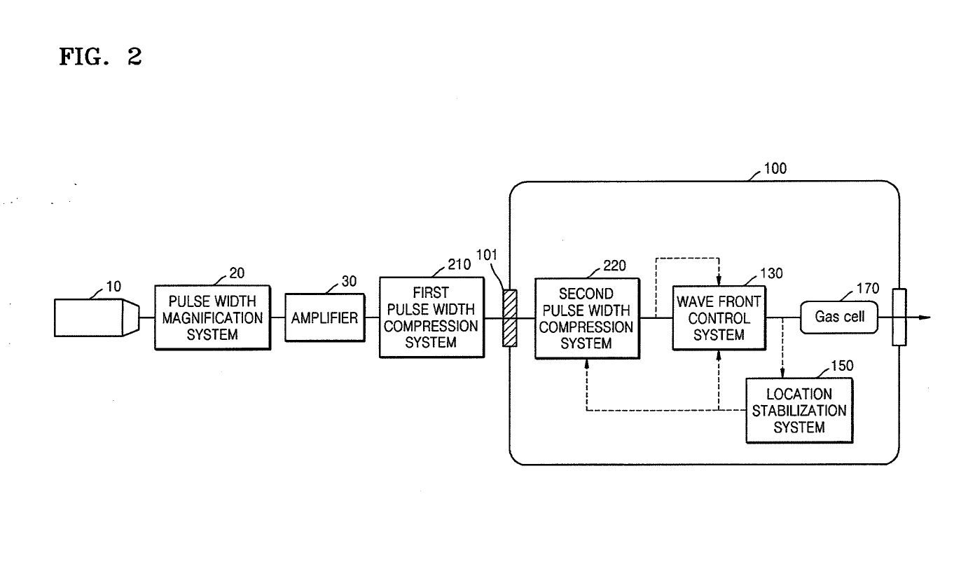

FIG. 2 illustrates a schematic view of a configuration of an EUV generation device 2, according to another embodiment. The same reference numerals denote the same elements in FIGS. 1 and 2, and redundant descriptions thereof are omitted here for convenience of description.

Referring to FIG. 2, compared to the EUV generation device 1 of FIG. 1, the EUV generation device 2 may include a first pulse width compression system 210 that compresses a pulse before laser beam is incident into the vacuum chamber 100 and a second pulse width compression system 220 disposed within the vacuum chamber 100. A compressibility of the first pulse width compression system 210 may be designed in consideration of a compressibility of the second pulse width compression system 220. The first pulse width compression system 210 and/or the second pulse width compression system 220 may include one of a diffraction grating pair, a prism pair, and a chirp mirror pair.

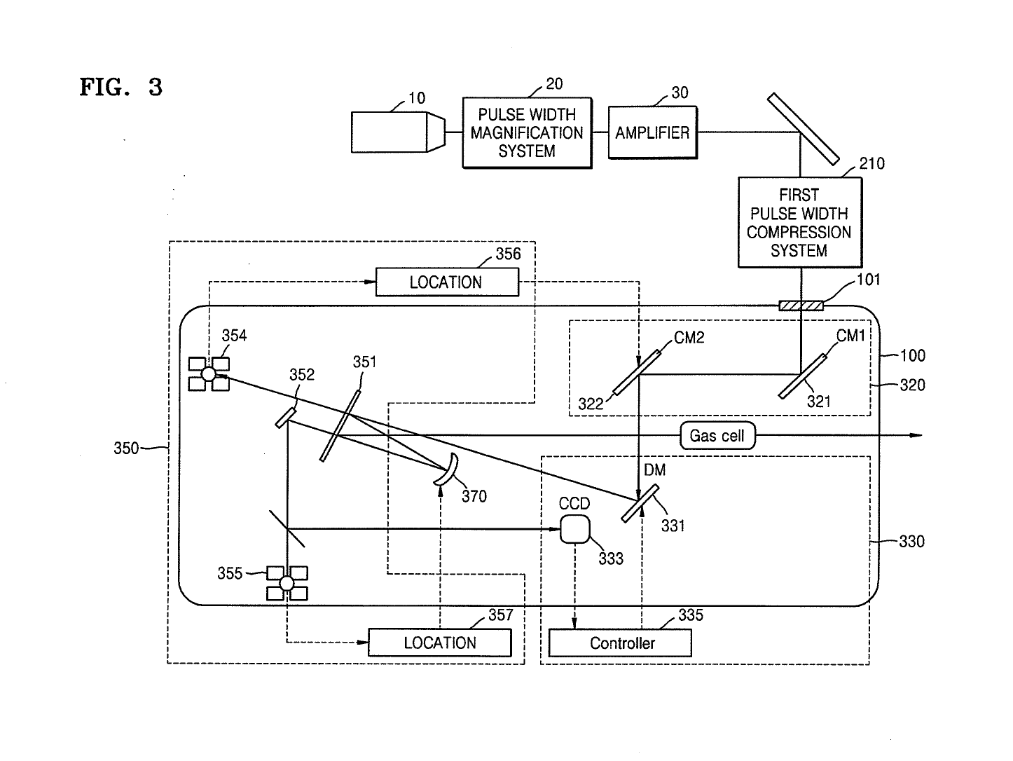

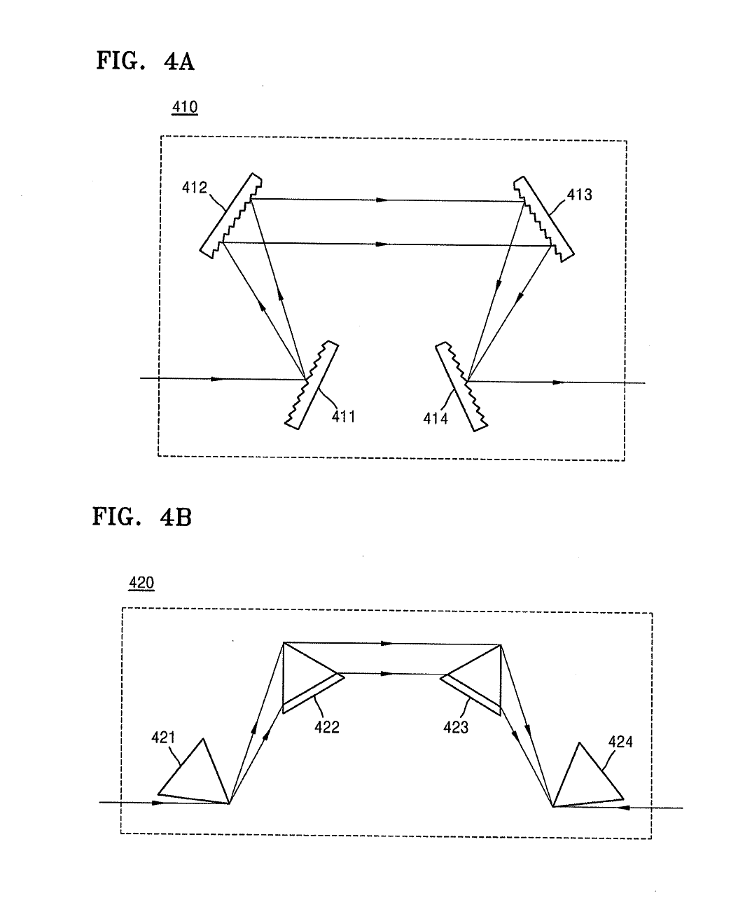

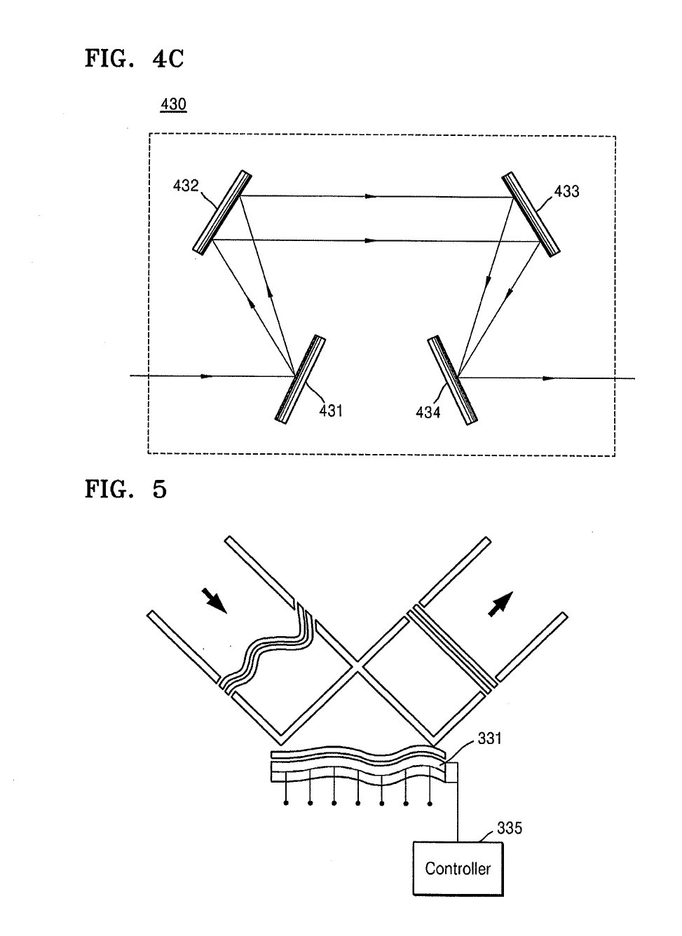

FIG. 3 illustrates a schematic view of a configuration of an EUV generation device 3, according to another embodiment. FIGS. 4A through 4C illustrate pulse width adjustment systems 410, 420, and 430 available in the pulse width magnification system 20 and the pulse width compression systems 110, 210, and 220 of the EUV generation devices 1, 2, and 3. FIG. 5 is a diagram for explaining a deformable mirror (DM) available in the EUV generation devices 1, 2, and 3. The same reference numerals denote the same elements in FIGS. 2 and 3, and redundant descriptions thereof are omitted here for convenience of description.

Referring to FIG. 3, a second pulse width compression system 320 includes a first chirp mirror CM1 321 and a second chirp mirror CM2 322. The first chirp mirror CM1 321 and the second chirp mirror CM2 322 may be paired to compress a pulse width of laser beam incident into the vacuum chamber 100. A distance between the first chirp mirror CM1 321 and the second chirp mirror CM2 322 and/or an angle therebetween may be adjusted to control a compressibility of the pulse width. Although the second pulse width compression system 320 includes a pair of chirp mirrors, i.e., the first chirp mirror CM1 321 and the second chirp mirror CM2 322 in FIG. 3, the pulse width adjustment systems 410 and 420 of FIGS. 4A through 4C may be used, and embodiments are not limited thereto.

FIG. 4A shows the Pulse width adjustment system 410 including diffraction gratings 411, 412, 413, and 414. Distances and/or angles between the diffraction gratings 411, 412, 413, and 414 may be adjusted to magnify or compress the pulse width of the laser beam incident into the pulse width adjustment system 410 and adjust magnification power and compressibility of the pulse width.

FIG. 4B shows the pulse width adjustment system 420 including prisms 421, 422, 423, and 424. Distances and/or angles between the prisms 421, 422, 423, and 424 may be adjusted to magnify or compress the pulse width of the laser beam incident into the pulse width adjustment system 420 and adjust magnification power and compressibility of the pulse width.

FIG. 4C shows the pulse width adjustment system 430 including chirp mirrors 431, 432, 433, and 434. Distances and/or angles between the chirp mirrors 431, 432, 433, and 434 may be adjusted to magnify or compress the pulse width of the laser beam incident into the pulse width adjustment system 430 and adjust magnification power and compressibility of the pulse width.

Therefore, the pulse width adjustment systems 410, 420, and 430 may be applied to the second pulse width compression system 220 as well as the first pulse width compression system 210 and/or the pulse width magnification system 20. FIGS. 4A through 4C merely illustrate examples of systems for adjusting a pulse width and embodiments are not limited thereto.

The pulse width of the laser beam may be compressed by about 50% by the second pulse width compression system 320. That is, the pulse width of the laser beam before passing through the second pulse width compression system 320 may be two or more times longer than a required pulse width to generate EUV. Therefore, when the laser beam passes through the window 101 of the vacuum chamber 100, SPM of the laser beam may be inhibited. The above-described compressibility is exemplary and is not limited thereto. In some embodiments, the pulse width of the laser beam incident into the second pulse width compression system 320 may be selectively compressed within a range of 30% and 60%.

The laser beam compressed by the second pulse width compression system 320 is incident on a wave front control system 330. The wave front control system 330 functions to compensate for a distortion of the laser beam and/or a distortion that occurs when the laser beam passes through optical components. The wave front control system 330 may include a wave front observing unit 333 for observing a wave front of the laser beam, a DM 331 for adjusting the wave front, and a controller 335 for adjusting the DM 331. The wave front observing unit 333 may include a charge coupled device (CCD) and/or a Shack-Hartmann sensor. The wave front control system 330 may control the wave front by using the DM 331 so as to obtain a desired wave front shape after observing the wave front in real time by using the wave front observing unit 333.

Referring to FIG. 5, the DM 331 may electrically control a shape of a mirror surface. Thus, the wave front of the laser beam may be observed by using the CCD (333 of FIG. 3), and the mirror surface of the DM 331 may be adjusted by the controller 335 so as to obtain the desired wave front shape based on the observed wave front of the laser beam. Genetic algorithm (GA) may be applied to adjust the DM 331. GA which is a method of obtaining an optimal solution is algorithm that mathematically models an evolving feature of a gene. The DM 331 includes several tens of individual controllers. GA may be applied to obtain an optimal value of each controller.

The laser beam compensated by the wave front control system 330 is focused by a focus mirror 370 and is incident on the gas cell 170. The focus mirror 370 functions to focus the laser beam so as to increase EUV generation efficiency. The EUV generation device 3 may include at least one mirror for adjusting a path so as to cause the laser beam to be incident into the gas cell 170.

A location stabilization system 350 may include a plane mirror 351 having partial transparency with respect to light, a first sensor 354 for measuring a signal of the laser beam from light that passes through a first point of the plane mirror 351 and a first location adjusting unit 356 for adjusting locations of optical components included in the vacuum chamber 100 based on the signal received from the first sensor 354. The location stabilization system 350 may include a second sensor 355 for measuring a signal of the laser beam from light that passes through a second point of the plane mirror 351 and reflected by a mirror 352, and a second location adjusting unit 357 for adjusting locations of optical components included in the vacuum chamber 100 based on the signal received from the second sensor 355.

Characteristics and locations of the optical components included in the EUV generation devices 1, 2, and 3 may be changed due to temperature and/or vibration. The location stabilization system 350 may compensate for these changes to consistently stabilize a path of the laser beam.

The focus mirror 370 may focus the laser beam compensated by the wave front control system 330. The plane mirror 351 may reflect a major part of the collected laser beam to be incident into the gas cell 170. In this regard, the collected laser beam may be directly incident into the gas cell 170 without passing through another optical component so that a distortion of the laser beam may not occur.

The plane mirror 351 may have partial transparency with respect to light to transmit the light to the first sensor 354 and the second sensor 355 that measure the signal of the laser beam. A sensor for measuring the signal of the laser beam may be further added if necessary.

To transmit the signal of the laser beam to the first sensor 354, the plane mirror 351 may be focused such that a part of the laser beam may be transmitted at the first point of the plane mirror 351. The signal transmitted to the first sensor 354 may be transferred to the first location adjusting unit 356 to feedback information regarding the path of the laser beam. The first location adjusting unit 356 may adjust locations of the optical components included in the second pulse width compression system 320 based on the feedback. For example, locations of the first chirp mirror 321 and/or the second chirp mirror 322 may be adjusted by the first location adjusting unit 356.

To transmit the signal of the laser beam to the second sensor 355, the plane mirror 351 may be focused such that a part of the laser beam may be transmitted at the second point of the plane mirror 351. The signal transmitted to the second sensor 355 may be transferred to the second location adjusting unit 357 to feedback information regarding the path of the laser beam. The second location adjusting unit 357 may adjust a location of the focus mirror 370 based on the feedback.

The first location adjusting unit 356 and the second location adjusting unit 357 may operate in real time and may optimize the path of the laser beam by using feedback through a closed loop.

As described above, the EUV generation device 3 includes the second pulse width compression system 320 disposed in the vacuum chamber 100 so that SPM which may occur when the laser beam passes through the window 101 of the vacuum chamber 100 may be inhibited. Further, the EUV generation device 3 may compensate for a distorted wave front of the laser beam by the wave front control system 330. The location stabilization system 350 of the EUV generation device 3 may use the plane mirror 351 to minimize the distortion of the laser beam incident into the gas cell 170.

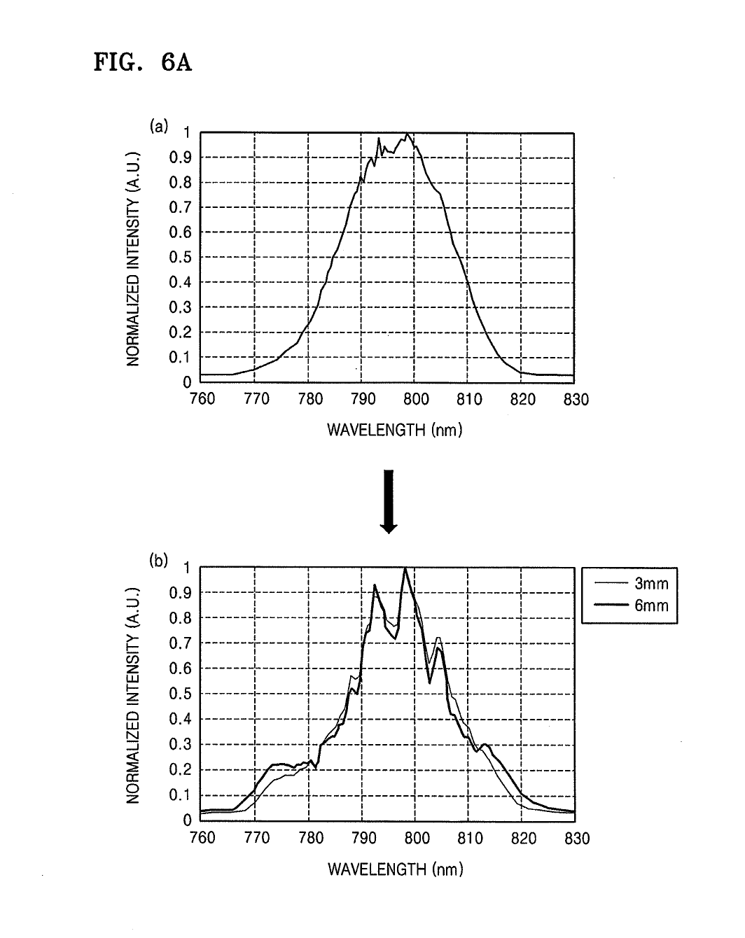

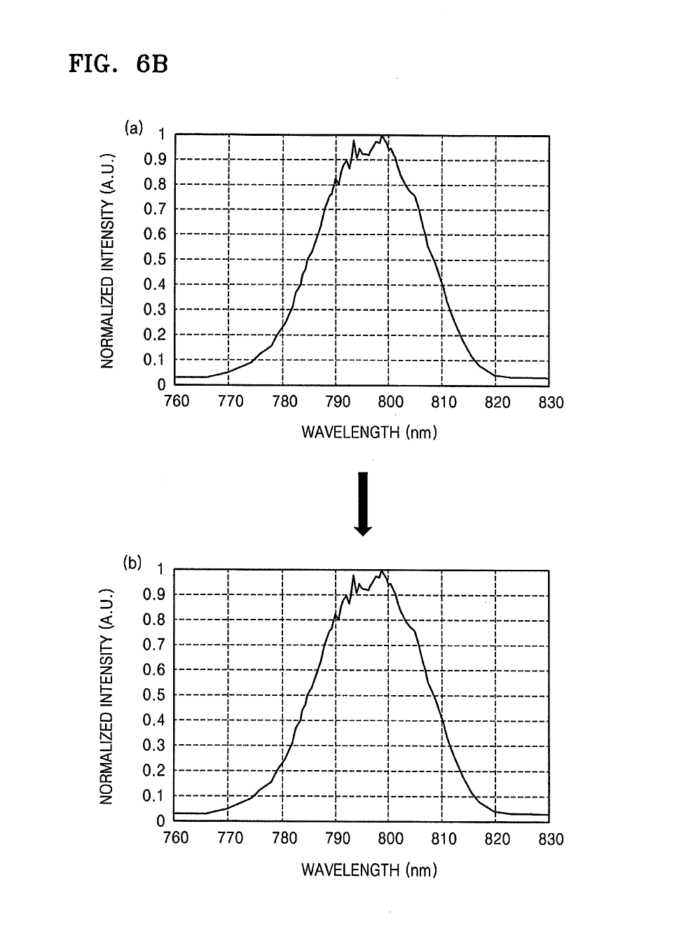

FIGS. 6A and 6B illustrate graphs for explaining a location of a pulse width compression system and a SPM signal. In FIGS. 6A and 6B, graph (a) indicates a spectrum of light output from the light source 10.

In FIG. 6A, graph (b) indicates a spectrum of the laser beam that passes through the window 101 when the second pulse width compression system 320 of the EUV generation device 3 is disposed outside the vacuum chamber 100. Referring to (b) of FIG. 6A, the second pulse width compression system 320 is disposed outside the vacuum chamber 100 so that the laser beam is compressed before passing through the window 101 of the vacuum chamber 100 and SPM occurs when passing through the window 101 of the vacuum chamber 100. A thick line indicates a thickness of 3 mm of the window 101. A thin line indicates a thickness of 6 mm of the window 101.

In FIG. 6B, graph (b) indicates a spectrum of the laser beam after passing through the second pulse width compression system 320 when the second pulse width compression system 320 is disposed in the vacuum chamber 100 like the embodiment described with reference to FIG. 3. In this case, the spectrum of (b) of FIG. 6B has almost the same shape as the spectrum of (a) of FIG. 6B, i.e., a spectrum of light output by the light source 10.

By way of summation and review, the EUV generation device according to embodiments may prevent a spectrum distortion phenomenon due to SPM, thereby generating highly reliable EUV. The EUV generation device may have an excellent EUV output characteristic and a long-term stability by employing a pulse width compression system in a vacuum chamber.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An extreme ultra violet (EUV) generation device, comprising:
a light source for outputting a laser beam;
a pulse width compression system for compressing a pulse width of the laser beam;
a gas cell for receiving the laser beam having the compressed pulse width incident from the pulse width compression system and generating EUV light; and
a vacuum chamber that houses the pulse width compression system and the gas cell.

2. The EUV generation device as claimed in claim 1, wherein the pulse width compression system comprises a chirp mirror.

3. The EUV generation device as claimed in claim 1, wherein the pulse width compression system selectively compresses the pulse width of the incident laser beam within a range of 30% and 60%.

4. The EUV generation device as claimed in claim 1, wherein the vacuum chamber comprises a wave front control unit for controlling a wave front of the laser beam incident into the gas cell.

5. The EUV generation device as claimed in claim 4, wherein the wave front control unit comprises a deformable mirror (DM).

6. The EUV generation device as claimed in claim 4, wherein the wave front control unit adjusts a wave front of the laser beam by applying genetic algorithm (GA).

7. The EUV generation device as claimed in claim 1, wherein the vacuum chamber comprises a location stabilization system for stabilizing a location of the laser beam.

8. The EUV generation device as claimed in claim 7, wherein the location stabilization system comprises:
a plane mirror having partial transparency with respect to light;
a first sensor for measuring a signal of the laser beam from light that transmits a first point of the plane mirror; and
a first location adjusting unit for adjusting locations of optical components included in the vacuum chamber based on the signal received from the first sensor.

9. The EUV generation device as claimed in claim 8, wherein the location stabilization system comprises:
a second sensor for measuring the signal of the laser beam from light that transmits a second point of the plane mirror; and
a second location adjusting unit for adjusting the locations of optical components included in the vacuum chamber based on the signal received from the second sensor.

10. The EUV generation device as claimed in claim 1, further comprising a focus mirror for collecting the laser beam incident into the gas cell.

11. The EUV generation device as claimed in claim 1, further comprising: between the light source and the vacuum chamber,
a pulse width magnification system for magnifying the pulse width of the laser beam; and
an amplifier for amplifying an output of the laser beam that passes through the pulse width magnification system.

12. The EUV generation device as claimed in claim 11, further comprising, between the amplifier and the vacuum chamber, another pulse width compression system for compressing the pulse width of the amplified laser beam to a first pulse width that is longer than a second pulse width output by the pulse width compression system in the vacuum chamber.

13. The EUV generation device as claimed in claim 12, further comprising a deformable mirror (DM) in the vacuum chamber and controlling a wave front of the laser beam incident into the gas cell.

14. The EUV generation device as claimed in claim 12, further comprising a location stabilization system disposed in the vacuum chamber and stabilizing a location of the EUV light output from the gas cell.

15. The EUV generation device as claimed in claim 14, wherein the second pulse width compression system comprises a chirp mirror.

16. An extreme ultra violet (EUV) generation device, comprising:
a vacuum chamber for housing a gas cell, a laser beam having a first pulse width being incident on a window in the vacuum chamber; and
a pulse width compression system in the vacuum chamber between the window and the gas cell, the pulse width compression system being configured to compress the first pulse width of the laser beam to a second pulse width shorter than the first pulse width, the gas cell being configured to output EUV light in response to the laser beam having the second pulse width.

17. The EUV generation device as claimed in claim 16, further comprising, between a light source outputting the laser beam and the vacuum chamber, another pulse width compression system for compressing the first pulse width to a third pulse width that is greater than the second pulse width.

18. The EUV generation device as claimed in claim 17, further comprising, between the light source and the another pulse width compression system,
a pulse width magnification system for magnifying the pulse width of the laser beam; and
an amplifier for amplifying an output of the laser beam that passes through the pulse width magnification system.

19. The EUV generation device of claim 16, further comprising a deformable mirror (DM) disposed in the vacuum chamber and controlling a wave front of the laser beam incident into the gas cell.

20. The EUV generation device of claim 16, further comprising a location stabilization system disposed in the vacuum chamber and stabilizing a location of the EUV light output from the gas cell.
